(19) United States
(12) Patent Application Publication
(10) Pub. No.: US 2006/0187551 A1
(43) Pub. Date: Aug. 24, 2006

(54) Reflector and method for producing the same

(75) Inventors: Wen-Hao Huang, Taichung (TW); Chien-Ming Huang, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Asia Optical Co., Inc.

(21) Appl. No.: 11/186,367

(22) Filed: Jul. 21, 2005

(30) Foreign Application Priority Data
Feb. 22, 2005 (TW) 94105211

(51) Int. Cl. G02B 1/10

(52) U.S. Cl. 359/582; 359/584

(57) ABSTRACT

A reflector and method for producing the same. The reflector comprises a glass substrate, an intermediate layer, consisting essentially of aluminum oxide, disposed on the substrate, a reflective silver layer disposed on the intermediate layer, and a passivation layer disposed on the silver layer.

### BACKGROUND

The invention relates to a reflector, and more specifically to a structure of a silver coated reflector.

Reflectors are typically utilized in a light delivery path in optical apparatuses such as cameras or projectors. Silver typically acts as a reflection layer on a reflector due to its high reflectivity in visible and infrared regions. Unfortunately, low adhesion between silver and a reflector substrate, darkening of silver surface from chemical reaction with air contaminants such as hydrogen sulfide, sulfur dioxide, or other sulfur containing molecules, and white spots from water condensation on silver surface caused by deviations in temperature and/or humidity, or other factors, negatively affect practicability and reliability of silver coated reflectors.

### SUMMARY

Thus, embodiments of the invention provide reflectors with improved adhesion between a reflective silver layer and substrate, preventing contamination of the silver surface, improving reflectivity, practicability, and reliability of the reflectors.

Embodiments of the invention provide a reflector comprising a glass substrate, an intermediate layer, a reflective silver layer, and a passivation layer. The intermediate layer, consisting essentially of aluminum oxide, is disposed on the substrate. The reflective silver layer is disposed on the intermediate layer. The passivation layer is disposed on the silver layer.

Embodiments of the invention further provide a method for producing the reflector. First, a glass substrate is provided. An intermediate layer, consisting essentially of aluminum oxide, is then formed on the substrate utilizing vacuum deposition. Further, a reflective silver layer is formed on the intermediate layer. Finally, a passivation layer is formed on the silver layer utilizing vacuum deposition.

### BRIEF DESCRIPTION OF THE DRAWINGS

The invention can be more fully understood by reading the subsequent detailed description in conjunction with the examples and references made to the accompanying drawings, wherein:

FIG. 1 is a cross-section of a reflector of one embodiment of the invention.

FIG. 2 is a cross-section of a reflector of an alternative embodiment of the invention.

FIG. 3 is a cross-section of a reflector of another alternative embodiment of the invention.

### DETAILED DESCRIPTION

The following embodiments are intended to illustrate the invention more fully without limiting the scope of the claims, since numerous modifications and variations will be apparent to those skilled in the art.

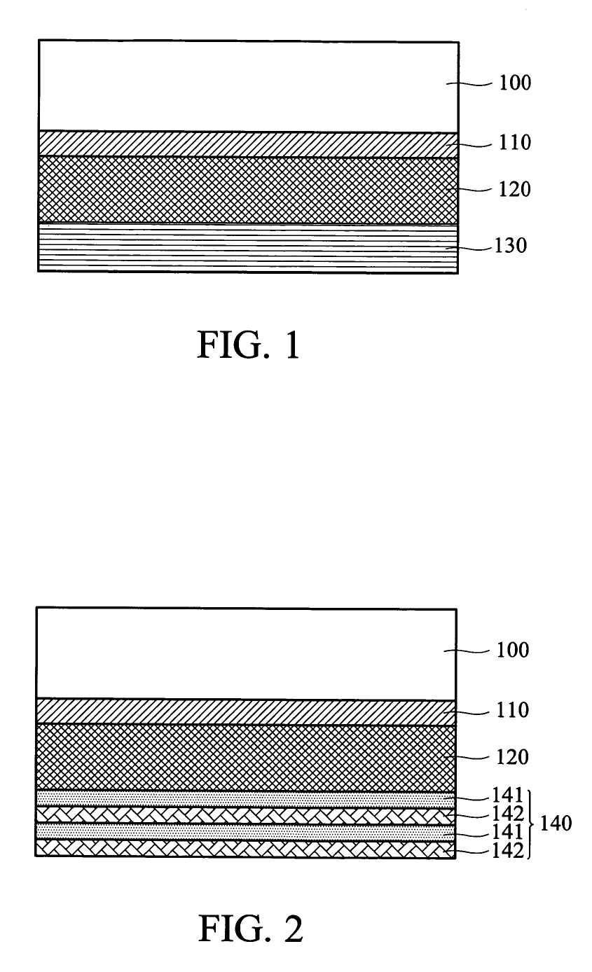

FIG. 1 is a cross-section of a reflector of a first embodiment of the invention, comprising a substrate 100, intermediate layer 110, reflective silver layer 120, and passivation layer 130.

The substrate 100 is preferably glass, receiving the intermediate layer 110 thereon utilizing a simpler process and/or cheaper materials. In some embodiments, the substrate 100 is resin, and thus, a silicon monoxide layer is formed thereon prior to forming the intermediate layer 110 to improve adhesion therebetween, resulting in complex process and materials for production.

The intermediate layer 110, preferably consisting essentially of aluminum oxide, is formed on the substrate 100 to improve adhesion between the substrate 100 and the subsequently formed reflective silver layer 120. The adhesion improvement is more apparent when utilizing glass substrate. The intermediate layer 110 is preferably about 10 to 1000 nm thick. When the intermediate layer 110 is less than 10 nm thick, uneven coating of the intermediate layer 100 typically occurs, decreasing the effect for improved adhesion of the reflective silver layer 120. When thickness of the intermediate layer 110 exceeds 1000 nm, process duration and cost thereof increase, and probability of bulk defects such as cracks or gas holes increases, resulting in delamination of the intermediate layer 110. In some embodiments, the intermediate layer 110 is a mixture of aluminum oxide and oxide of transition metals with more complex formation process and higher cost.

The passivation layer 130 is formed on the reflective silver layer 120 to protect the reflective silver layer 120 from contamination by sulfur, water, or other contamination substances, and thus, the reflective silver layer 120 may maintain original reflective function for a long period. The passivation layer 130 can be a single aluminum oxide layer, multi-layered film, or other materials able to completely protect the reflective silver layer 120. In this embodiment, the passivation layer is aluminum oxide of about 10 to 100 nm thick depending on the needs of environment or other factors.

The reflector can be produced by a subsequent flow, for example. First, the substrate 100 is provided. Preliminary treatments optionally performed on the substrate 100 remove surface defects and achieve predetermined surface roughness, curvature, or other properties required by reflectors. The intermediate layer 110 is then formed on the substrate 100 utilizing vacuum deposition (e.g. evaporation, ion beam assisted deposition (IBAD), sputtering, or reactive sputtering) or other film formation methods. The thickness of the intermediate layer 110 is controlled by parameters such as deposition time.

Next, the reflective silver layer 120 is formed on the intermediate layer 110 utilizing vacuum deposition (e.g. evaporation, IBAD, sputtering, or reactive sputtering) as desired, or other film formation methods.

Finally, the passivation layer 130 is formed on the reflective silver layer 120 utilizing evaporation, IBAD, sputtering (e.g. reactive sputtering), or other film formation methods. The thickness of the passivation layer 130 is controlled by parameters such as deposition time.

FIG. 2 is a cross-section of a reflector of a second embodiment of the invention, replacing the passivation layer 130 shown in FIG. 1 with a passivation layer 140. Details regarding the substrate 100, intermediate layer 110, and reflective silver layer 120 are the same as those described for FIG. 1, and thus, are omitted in the following.

In this embodiment, the passivation layer 140 comprises a multilayered reflection enhancement film. In addition to protecting the reflective silver layer 120 from contamination, the passivation layer 140 further improves reflectivity of the reflector.

The passivation layer 140, comprising an alternate structure of at least one high-refraction index layer 141 and at least one low-refraction index layer 142, provides high reflectivity due to multilayer interference to further improve the reflectivity of the reflector. Note that the order and quantity of the layers 141, 142 shown in FIG. 2 are exemplary, and not intended to limit the scope of the invention. The order and quantity of the layers 141, 142 depend on user requirements. Either layer 141 or 142 can be formed first. The terms “high”-refraction index layer 141 and “low”-refraction index layer 142 are relative to each other. For example, the refractive index of the layer 141 is approximately 1.7 or greater, of a material such as titanium oxide, tantalum oxide, or other. The refractive index of the layer 142 is between 1.3 and 1.5, for a material such as silicon oxide.

The thicknesses of the layers 141, 142 depend on user requirement such as wavelength of the reflected light or other factors. The passivation layer 140 is preferably between 10 and 1000 nm thick.

The passivation layer 140 can be formed on the reflective silver layer 120 by alternative deposition of the layers 141, 142 utilizing vacuum deposition (e.g. evaporation, IBAD, sputtering, or reactive sputtering) or other film formation methods until reaching predetermined layer number and thickness.

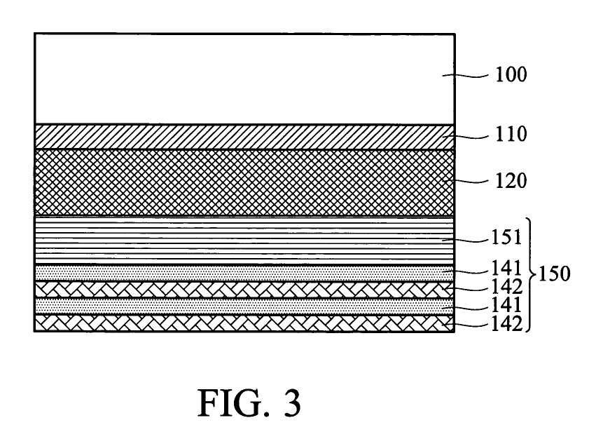

FIG. 3 is a cross-section of a reflector of a third embodiment of the invention. Compared to FIG. 2, an additional second aluminum oxide layer 151 is disposed between the reflective silver layer 120 and the reflection enhancement film. The combination of the second aluminum oxide layer 151 and reflection enhancement film acts as a passivation layer 150. The passivation layer 150 provides both protection of the reflective silver layer 120 from contamination and improvement of the reflectivity of the reflector. The additional second aluminum oxide layer 151 further improves adhesion between the reflective silver layer 120 and the reflection enhancement film, further improving reliability of the reflector. Details regarding the substrate 100, intermediate layer 110, reflective silver layer 120, and layers 141, 142 are the same as those described for FIGS. 1 and 2, and thus, are omitted in the following. Moreover, the thickness of the second aluminum oxide layer 151 depends on users' requirement, being, for example, between 10 and 100 nm.

The second aluminum oxide layer 151 is formed on the reflective silver layer 120 by vacuum deposition (e.g. evaporation, IBAD, sputtering, or reactive sputtering) or other film formation methods. The thickness of the second aluminum oxide layer 151 is controlled by parameters such as deposition time.

Next, the layers 141, 142 are formed on the second aluminum oxide layer 151 by the described flow to complete the passivation layer 150.

Thus, the results show efficacy of the inventive reflector, resulting in improving adhesion between the reflective silver layer and substrate, and increased reflectivity, practicability, and reliability of the reflector. Moreover, the optional multilayered reflection, enhancement film comprising an alternate structure of at least one high-refraction index layer and at least one low-refraction index layer, further improves the reflectivity of the reflector.

While the invention has been described by way of example and in terms of preferred embodiment, it is to be understood that the invention is not limited thereto. It is therefore intended that the following claims be interpreted as covering all such alteration and modifications as fall within the true spirit and scope of the invention.

What is claimed is:

1. A reflector, comprising:
a glass substrate;
an intermediate layer, consisting essentially of aluminum oxide, disposed on the substrate;
a reflective silver layer disposed on the intermediate layer; and
a passivation layer disposed on the silver layer.

2. The reflector in claim 1, wherein the intermediate layer is about 10 to 1000 nm thick.

3. The reflector in claim 1, wherein the passivation layer comprises aluminum oxide.

4. The reflector in claim 1, wherein the passivation layer is about 10 to 100 nm thick.

5. The reflector in claim 1, wherein the passivation layer comprises a multilayered reflection enhancement film comprising an alternate structure of at least one high-refraction index layer and at least one low-refraction index layer.

6. The reflector in claim 5, wherein the multilayered reflection enhancement film is about 10 to 1000 nm thick.

7. The reflector in claim 5, wherein the refractive index of the high-refraction index layer is 1.7 or greater, and that of the low-refraction index layer is between 1.3 and 1.5.

8. The reflector in claim 1, wherein the passivation layer further comprises:
a second aluminum oxide layer disposed on the silver layer; and
a multilayered reflection enhancement film, comprising an alternate structure of at least one high-refraction index layer and at least one low-refraction index layer, disposed on the second aluminum oxide layer.

9. The reflector in claim 8, wherein the second aluminum oxide layer is about 10 to 100 nm thick, and the multilayered reflection enhancement film is about 10 to 1000 nm thick.

10. The reflector in claim 8, wherein the refractive index of the high-refraction index layer is 1.7 or greater, and that of the low-refraction index layer is between 1.3 and 1.5.

11. A method for producing a reflector, comprising:
providing a glass substrate;
forming an intermediate layer, consisting essentially of aluminum oxide, on the substrate utilizing vacuum deposition;
forming a reflective silver layer on the intermediate layer; and
forming a passivation layer on the silver layer utilizing vacuum deposition.

12. The method as claimed in claim 11, wherein the intermediate layer is about 10 to 1000 nm thick.

13. The method as claimed in claim 11, wherein the passivation layer comprises aluminum oxide.

14. The method as claimed in claim 11, wherein the the passivation layer is about 10 to 100 nm thick.

15. The method as claimed in claim 11, wherein the passivation layer comprises a multilayered reflection enhancement film comprising an alternate structure of at least one high-refraction index layer and at least one low-refraction index layer.

16. The method as claimed in claim 15, wherein the multilayered reflection enhancement film is about 10 to 1000 nm thick.

17. The method as claimed in claim 15, wherein the refractive index of the high-refraction index layer is 1.7 or greater, and that of the low-refraction index layer is between 1.3 and 1.5.

18. The method as claimed in claim 11, wherein formation of the passivation layer further comprises:
forming a second aluminum oxide layer on the silver layer; and
forming a multilayered reflection enhancement film, comprising an alternate structure of at least one high-refraction index layer and at least one low-refraction index layer, on the second aluminum oxide layer.

19. The method as claimed in claim 18, wherein the second aluminum oxide layer is about 10 to 100 nm thick, and the multilayered reflection enhancement film is about 10 to 1000 nm thick.

20. The method as claimed in claim 18, wherein the refractive index of the high-refraction index layer is 1.7 or greater, and that of the low-refraction index layer is between 1.3 and 1.5.
